(19) United States
(12) Patent Application Publication
(10) Pub. No.: US 2010/0301994 A1
(43) Pub. Date: Dec. 2, 2010

(54) ANTI-TAMPER DEVICE, METHOD OF CONTROLLING AN ANTI-TAMPER DEVICE, AND A FISCAL PRINTER USING THE SAME

(75) Inventor: Tsuyoshi Wasamoto, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/789,381

(22) Filed: May 27, 2010

(30) Foreign Application Priority Data
May 28, 2009 (JP) 2009-129076
Apr. 8, 2010 (JP) 2010-089268

(51) Int. Cl. G05B 19/00

(52) U.S. Cl. 340/5.2

(57) ABSTRACT

Anti-tamper devices, control methods for electronic appliances having an anti-tamper device, and fiscal printers having an anti-tamper device are disclosed. A control method for an electronic appliance having an anti-tamper device includes detecting a removal sequence of a plurality of fasteners from the electronic appliance, comparing the specified removal sequence with the detected removal sequence, and, when the compared sequences differ, limiting one or more specific operations of the electronic appliance or causing the electronic appliance to execute one or more specific operations. A corresponding plurality of sensors can be used to monitor the installation states of the fasteners. The specified removal sequence can be changed based on time kept by a timer. The detected removal sequence and the specified removal sequence can be stored in memory and compared by a control unit.

### CROSS-REFERENCES TO RELATED APPLICATIONS

This application claims priority to Japanese Patent Application No. 2009-129076, filed on May 28, 2009 and Japanese Patent Application No. 2010-089268, filed Apr. 8, 2010, the entire disclosures of which are expressly incorporated by reference herein.

### BACKGROUND

1. Technical Field

The present invention relates generally to an anti-tamper device and a method of controlling an anti-tamper device, and relates more particularly to an anti-tamper device housing an electronic component that records specific data, and a method of controlling the anti-tamper device. The present invention also relates to a fiscal printer having this anti-tamper device.

2. Related Art

Electronic devices that have a circuit board with electronic components such as memory devices, including RAM or ROM devices, for recording data, such as accounting information and other confidential data, are known from the literature. In order to prevent unauthorized electronic or mechanical access to any electronic component that stores confidential data, an electronic component storing confidential data is commonly disposed in a sealed structure such as taught in Japanese Unexamined Patent Appl. Pub. JP-A-2008-64868.

Because the housing must be opened in order for a service repairman or technician to repair or replace any components when maintenance of the electronic components is required, the housing must be configured to be opened. As a result, someone other than the service repairman may open the housing for purposes other than maintenance and thereby gain access to the circuit board holding the electronic component(s) that stores confidential data.

Furthermore, even if the electronic component is in a sealed package such as taught in JP-A-2008-64868, the circuit board containing the electronic component storing the confidential data is exposed when the housing is opened. The seal around the electronic component can then be broken and the electronic component tampered with, and the housing can then be closed again and the compromised electronic component can continue to be used.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An anti-tamper device and a control method for an electronic appliance having an anti-tamper device are disclosed. Such a device and method can be used to help protect confidential information stored within an electronic appliance. For example, the disclosed anti-tamper device can monitor for unauthorized access to an interior compartment of the electronic appliance in which a device storing confidential information is located. Such unauthorized access can be detected by detecting the sequence by which fasteners are removed from the electronic appliance and comparing the detected removal sequence with a specified removal sequence. A service repairman can be provided with the specified removal sequence. When someone other than the service repairman opens the interior compartment of the electronic appliance to tamper with the contents and removes the fasteners in a sequence that differs from the specified removal sequence, the disclosed anti-tamper device detects the unauthorized access. Action can then be taken to protect the confidential data. For example, upon detection of a removal sequence that differs from the specified removal sequence, one or more specific operations of the electronic appliance can be limited or the electronic appliance can be caused to execute one or more specific operations.

Thus, in a first aspect, an anti-tamper device is disclosed. The anti-tamper device includes an electronic component that records specific data, a case housing the electronic component thereinside, a cover that covers the case, a plurality of fasteners that fasten the cover to the case, a plurality of sensors that are disposed in the case and change state when the fasteners are removed, a control unit that detects the state changes of the sensors, a specified sequence recording unit that records a specified sequence for state changes in the sensors, and a detection sequence recording unit that records the order in which the state changes of the sensors were detected when the control unit detects a state change in the sensors. The control unit compares the specified sequence recorded in the specified sequence recording unit with the detected order of the state changes in the sensors recorded in the detection sequence recording unit. When the compared sequences differ, the control unit limits one or more specific operations of an electronic appliance or causes the electronic appliance to execute one or more specific operations. The control unit can be configured to detect state changes in the sensors when the fasteners are installed.

The specified sequence can be changed to, for example, increase the level of protection for confidential data stored within the electronic component. For example, the anti-tamper device can include a timer and the control unit can change the specified sequence recorded in the specified sequence recording unit based on time kept by the timer.

The comparison of the detected removal sequence and the specified removal sequence can be performed when power supplied to the control unit is turned on. For example, the control unit of the anti-tamper device can compare the specified sequence recorded in the specified sequence recording unit with the detected order of the state changes in the sensors recorded in the detection sequence recording unit when power supplied to the control unit is turned on. Because tampering often occurs when the power is turned off, this aspect of the invention detects the removal sequence even when the power is off and then compares the detected removal sequence and the specified removal sequence when the power is turned on so as to detect if tampering has occurred while the power was off.

In another aspect, a control method is disclosed for an electronic appliance having an anti-tamper device. The method includes detecting a removal sequence of a plurality of fasteners from the electronic appliance, comparing a specified removal sequence with the detected removal sequence, and, when the compared sequences differ, limiting one or more specific operations of the electronic appliance or causing the electronic appliance to execute one or more specific operations. The specified removal sequence can be stored, for example, in a specified sequence recording unit.

Sensors can be used to detect when each of the fasteners are removed. For example, the method can include monitoring the installation state of the fasteners via a corresponding plurality of sensors. The order in which the state changes of the fasteners are detected can be recorded in a detection sequence recording unit.

In another aspect, a fiscal printer is disclosed. The fiscal printer includes an electronic journal memory that records fiscal information related to sales transactions, a case housing the electronic journal memory thereinside, a cover that covers the case, a plurality of fasteners that fasten the cover to the case, a plurality of sensors that are disposed in the case and change state when the fasteners are removed, a control unit that detects the state changes of the sensors, a specified sequence recording unit that records a specified sequence for state changes in the sensors, and a detection sequence recording unit that records the order in which the state changes of the sensors were detected when the control unit detects a state change in the sensors. The control unit compares the specified sequence recorded in the specified sequence recording unit with the detected order of the state changes in the sensors recorded in the detection sequence recording unit. When the compared sequences differ, the control unit prohibits access to the electronic journal memory. The control unit can be configured detect state changes in the sensors when the fasteners are installed.

The specified sequence can be changed to, for example, increase the level of protection for confidential data stored within the electronic journal memory. For example, the fiscal printer can include a timer and the control unit can change the specified sequence recorded in the specified sequence recording unit based on time kept by the timer.

The comparison of the detected removal sequence and the specified removal sequence can be performed when power supplied to the control unit is turned on. For example, the control unit of the anti-tamper device can compare the specified sequence recorded in the specified sequence recording unit with the detected order of the state changes in the sensors recorded in the detection sequence recording unit when power supplied to the control unit is turned on. Because tampering often occurs when the power is turned off, this aspect of the invention detects the removal sequence even when the power is off and then compares the detected removal sequence and the specified removal sequence when the power is turned on so as to detect if tampering has occurred while the power was off.

If someone other than an authorized technician, for example, does not remove the screws or other fasteners in the predetermined specified order and opens the cover, the fiscal printer can be rendered inoperable or prevented from executing certain operations, such as recording certain data to the electronic journal memory. The fiscal printer can also be made to perform a specific operation, such as displaying an error. Tampering can thus be prevented.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an oblique view of a printer as an example of an electronic appliance having an anti-tamper device according to an embodiment of the invention.

FIG. 2 is an oblique view of the printer of FIG. 1 from the bottom.

FIG. 3 is an exploded oblique view illustrating the attachment of a bottom panel that is used as a cover to cover the anti-tamper device of the printer of FIG. 1.

FIG. 4 is a section view through line A-A in FIG. 2 illustrating the bottom panel and the anti-tamper device of the printer of FIG. 1.

FIG. 5 schematically illustrates the electrical connection of a push switch used in an anti-tamper device in the (a) on position and the (b) off position, in accordance with an embodiment.

FIG. 6 is a schematic block diagram illustrating a control circuit board of the anti-tamper device according to an embodiment of the invention.

FIG. 7 is a flow chart illustrating steps in a control method for an electronic appliance having an anti-tamper device according to an embodiment of the invention.

FIG. 8 is a flow chart illustrating steps in another control method for an electronic appliance having an anti-tamper device according to an embodiment of the invention.

### DETAILED DESCRIPTION

In the following description, various embodiments of the present invention will be described. For purposes of explanation, specific configurations and details are set forth in order to provide a thorough understanding of the embodiments. However, the present invention can be practiced without the specific details. Furthermore, well-known features may be omitted or simplified in order not to obscure the embodiment being described.

Preferred embodiments of an anti-tamper device and an electronic device control method using the anti-tamper device according to the present invention are described below with reference to the accompanying figures.

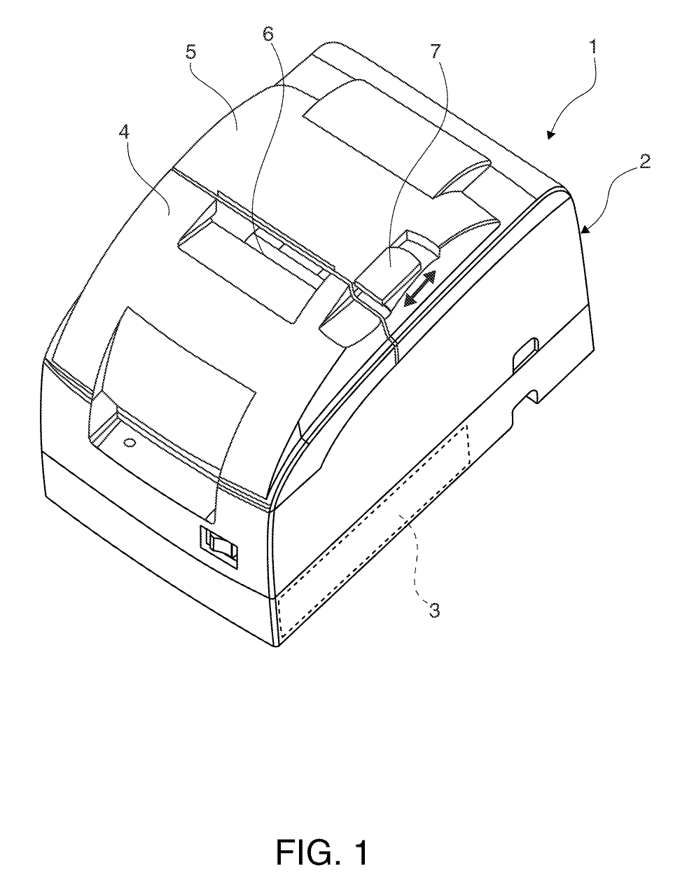

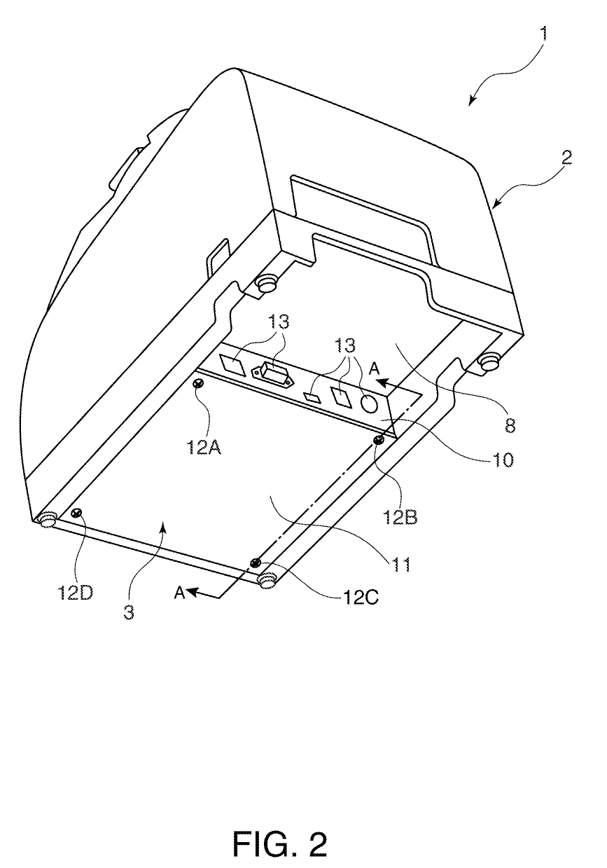

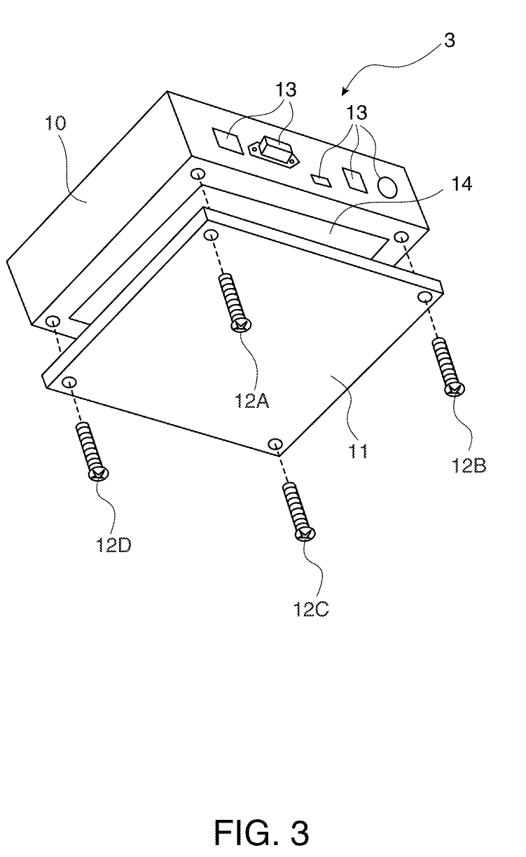

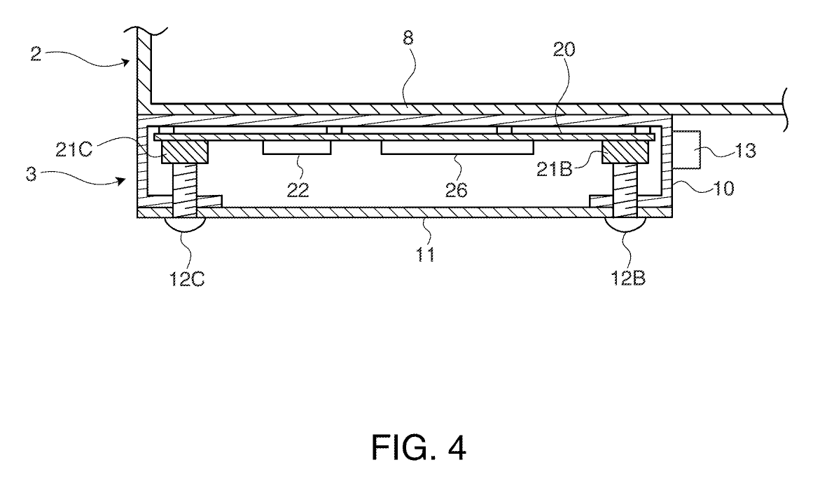

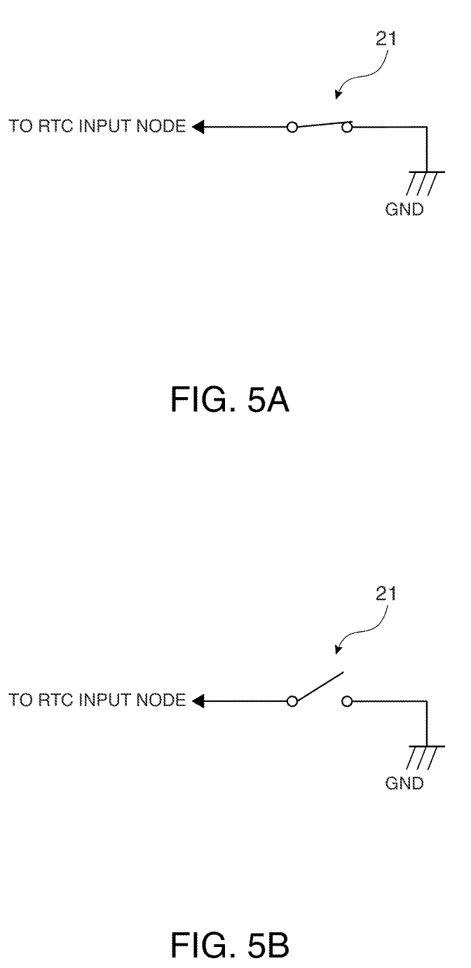

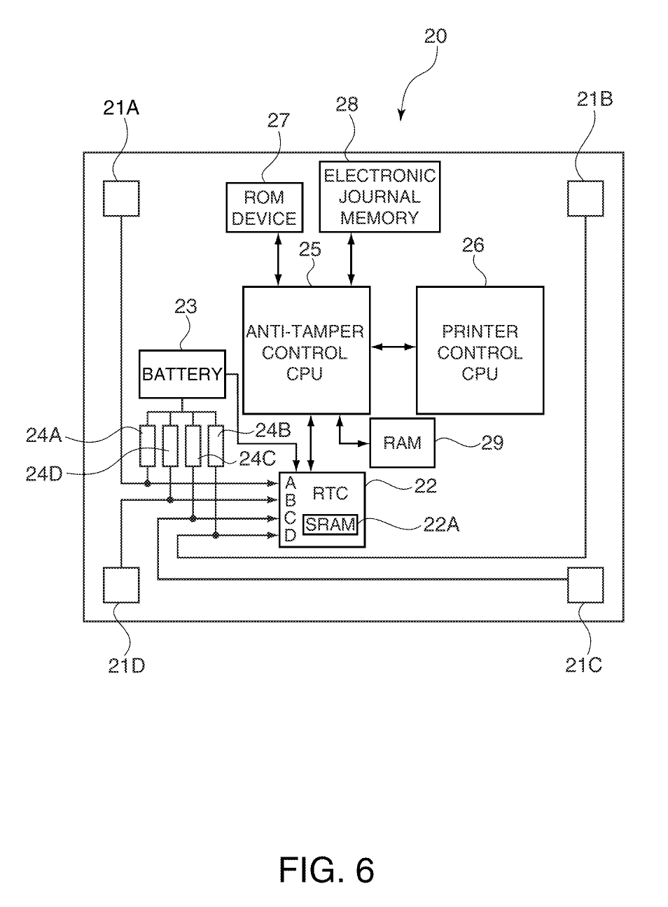

FIG. 1 is an oblique view of a printer as an example of an electronic appliance having an anti-tamper device according to an embodiment of the invention. FIG. 2 is an oblique view of the printer of FIG. 1 from the bottom. FIG. 3 is an exploded oblique view illustrating the attachment of a bottom panel that is used as a cover to cover the anti-tamper device of the printer of FIG. 1. FIG. 4 is a section view through line A-A in FIG. 2 illustrating the bottom panel and the anti-tamper device of the printer of FIG. 1. FIG. 5 schematically illustrates the electrical connection of a push switch used in an anti-tamper device in the (a) on position and the (b) off position, in accordance with an embodiment. FIG. 6 is a schematic block diagram illustrating a control circuit board of the anti-tamper device according to an embodiment of the invention.

An anti-tamper device for an electronic appliance according to a first embodiment of the invention is described below. Although the illustrated electronic appliance is a printer, the anti-tamper device can be used with other electronic appliances. As shown in FIG. 1 and FIG. 2, the printer 1 (electronic device) has a printer housing 2 and an anti-tamper device 3 that is affixed to the bottom side of the bottom part 8 of the printer housing 2. Disposed in the printer housing 2 are a recording medium storage unit, a recording medium transportation mechanism, and a print head, for example. A control circuit board 20 that controls the printer 1 (electronic device) is disposed inside the anti-tamper device 3.

The printer housing 2 includes a front access cover 4 that covers the top front part of the printer 1, and a rear access cover 5 that covers the back part of the top of the printer 1. A paper exit 6 is formed widthwise between the access covers 4 and 5. The rear access cover 5 can be opened by operating a sliding button 7 located beside the paper exit 6 to unlock the cover locking mechanism (not shown in the figure). When the rear access cover 5 is open, the storage compartment for the recording medium is exposed and the recording medium can be loaded or replaced, for example. When the front access cover 4 is opened, the ink ribbon, for example, can be loaded or replaced.

The anti-tamper device 3 includes a device case 10 and a bottom panel 11 that covers the open part 14 of the case 10. The bottom panel 11 is affixed so that it covers the open part 14 of the case 10 by means of four screws 12 (screws 12A, 12B, 12C, 12D) used as fasteners at the four corners of the case 10. A group of connectors 13 enabling connection to a host computer, for example, is disposed at the back side of the case 10.

As shown in section view in FIG. 4, the control circuit board 20 is located inside the case 10. As shown in FIG. 4 and FIG. 6, a push switch 21 (21A, 21B, 21C, 21D) is disposed at each of the four corners of the control circuit board 20 at positions where each push switch 21 will contact the distal end part of one of the four screws 12 (12A, 12B, 12C, 12D). When the screws 12 in the bottom panel 11 are tightened, each push switch 21 is pressed by the distal end of the corresponding screw 12 and turns on. The push switches 21 (21A, 21B, 21C, 21D) thus function as sensors that sense the installation and removal of the screws 12 (12A, 12B, 12C, 12D).

As shown in FIG. 6, the control circuit board 20 is primarily populated by these push switches 21 (21A, 21B, 21C, 21D) that function as sensors; a real-time clock counter 22 (RTC) that functions as a timer; a battery 23; resistors 24 (24A, 24B, 24C, 24D); an anti-tamper control CPU 25; a printer control CPU 26; a ROM device 27 such as an OTP-ROM (one-time-programmable read-only memory) device enabling data to be written once but not erased or overwritten; electronic journal memory 28 (EJ memory) such as a NAND FLASH device or other electronic component for recording confidential data; and RAM 29 that is used as working memory for program execution.

As shown in FIG. 5 and FIG. 6, one side of each push switch 21 is connected to ground GND, and the other side is connected to an input node (A to D) of the real-time clock counter 22. When the push switch 21 is on, the push switch 21 goes to ground GND as shown in FIG. 5A, and when the switch 21 is off, the switch is open and the connection to ground GND is interrupted as shown in FIG. 5B.

As shown in FIG. 6, the signal path between each push switch 21 (21A, 21B, 21C, 21D) and the corresponding input node (A to D) of the real-time clock counter 22 passes through a resistor 24 (24A, 24B, 24C, 24D), and is pulled up to the power supply potential of the battery 23. Each input node is therefore low whenever the push switch is on, but when the corresponding screw 12 (12A, 12B, 12C, 12D) is removed, the switch turns off, the potential of the corresponding input node (A to D) goes high, and this state change is detected by the real-time clock counter 22. The real-time clock counter 22 is connected so that power is supplied thereto from the battery 23. The real-time clock counter 22 is communicably connected to the anti-tamper control CPU 25, and anti-tamper control CPU 25 is communicably connected to the printer control CPU 26, and these function cooperatively as a control unit.

In order to remove the bottom panel 11 from the case 10, the screws 12 (12A, 12B, 12C, 12D) in the bottom panel 11 must all be removed. Because power is supplied from the battery 23 to the real-time clock counter 22 even when the printer 1 power is off, change in the input signal (change from a low level to a high level) that is input to the input nodes (A to D) is detected, and the name of the input node (A to D) and the time are stored sequentially to a desired plurality of storage areas (addresses) reserved as detection sequence recording units in SRAM (static random access memory) 22A in the real-time clock counter 22.

For example, the time and the name of the node in which a state change was first detected is stored to address 1, the time and the name of the node in which a state change was detected second is stored to address 2, the time and the name of the node in which a state change was detected third is stored to address 3, and the time and the name of the node in which a state change was detected fourth is stored to address 4. Yet more specifically, when the screws 12 (12A, 12B, 12C, 12D) are removed, the order in which the screws are removed and the time when each screw is removed are recorded in the detection sequence recording units in SRAM 22A.

Because there are four push switches 21 (21A, 21B, 21C, 21D) disposed to the control circuit board 20, there are 24 different sequences in which the screws 12 (12A, 12B, 12C, 12D) can be removed. If one or more of these 24 different screw removal patterns is set as the specified sequence for the state change in the push switches 21 (21A, 21B, 21C, 21D) (the authorized removal order), and the screws 12 (12A, 12B, 12C, 12D) are removed in a different order, the possibility that the cover was opened for tampering can be detected.

In addition, if the specified sequence for the state change in the push switches 21 (21A, 21B, 21C, 21D) (the authorized removal order) is changed to a different pattern after a specified time interval, the possibility of unauthorized opening of the cover can be detected even more reliably.

When the printer 1 power turns on, power is also supplied to the control circuit board 20 of the anti-tamper device 3, and the anti-tamper control CPU 25 executes the process for the startup sequence when the power turns on. During this startup sequence the anti-tamper control CPU 25 first communicates with the real-time clock counter 22 and acquires the screw removal sequence and time information recorded in the detection sequence recording units of the SRAM 22A. The anti-tamper control CPU 25 then compares the specific sequence in which the data was recorded to the specified sequence recording unit with the sequence in which the state changes of the plural push switches 21 were detected and recorded in the detection sequence recording units to determine if the sequences differ.

If the anti-tamper control CPU 25 determines that the sequences differ, the bottom panel 11 may have been opened illicitly and the anti-tamper control CPU 25 sends an error report command to the printer control CPU 26. The printer control CPU 26 receives the error report command, limits specific operations of the printer 1, and prevents the printer 1 from operating normally when the power is turned on. Alternatively, a specific operation may be executed to report the error. For example, a buzzer may be sounded or an error may be displayed on a display unit not shown such as a liquid crystal display (LCD) or light-emitting diode (LED) display device to inform the user of illicit opening. Yet further preferably, access to the electronic journal memory 28 that records confidential data may be prohibited, for example.

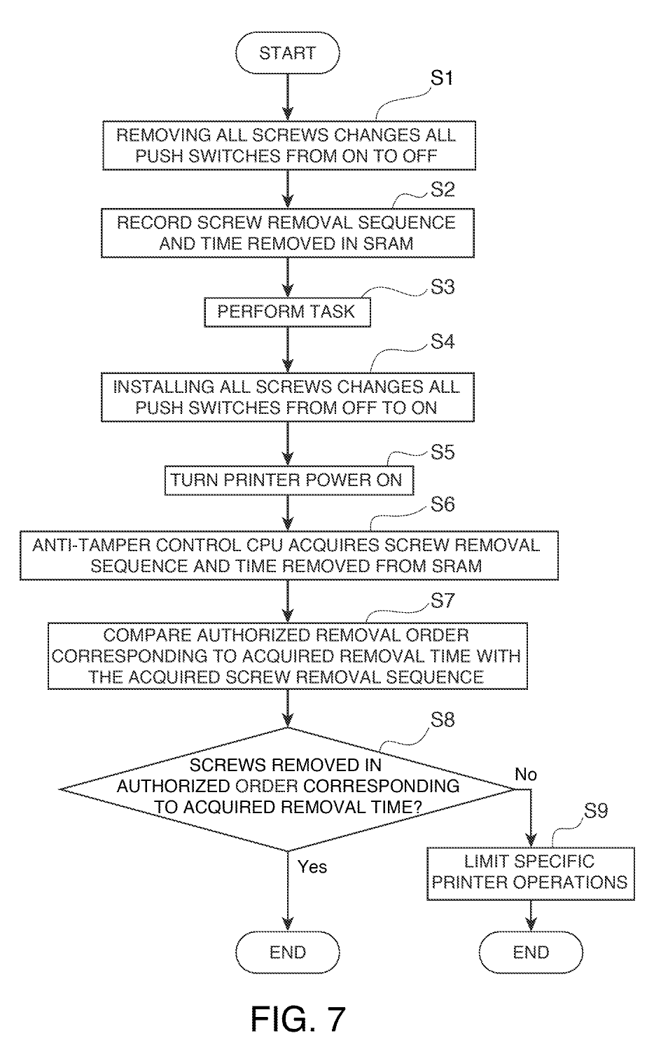

The electronic device control method of the anti-tamper device according to this embodiment of the invention is described next with reference to the flow chart in FIG. 7. FIG. 7 is a flow chart illustrating steps in a control method for an electronic appliance having an anti-tamper device according to an embodiment of the invention.

When maintenance of the control circuit board 20 in the printer 1 (electronic device) is required, the service repairman or other technician (simply “technician” below) contacts the administration center that manages information about the authorized removal order to acquire the authorized removal order at the current time. The administration center then verifies the technician and teaches the authorized removal order at the current time. The technician then turns the printer 1 power off and removes all of the screws 12 (12A, 12B, 12C, 12D) in the bottom panel 11 in the authorized removal order received from the administration center. The push switches 21 (21A, 21B, 21C, 21D) of the control circuit board 20 thus turn from on to off in the order in which they are removed (step S1).

It should be noted that each technician (such as the service repairman) could have a chart recording the authorized removal order at various times and refer to this chart to remove the screws, but each technician must then be responsible for that chart, thus increasing the possibility of information leaks compared with a configuration in which an administration center centrally manages the information.

When the state of a push switch 21 changes, the input signal level of the input nodes A to D of the real-time clock counter 22 changes from low to high, and the input node name and time are recorded in the order in which the state changes occur to a specific plurality of storage areas (addresses) that are the detection sequence recording units in the SRAM 22A. More specifically, the order in which the screws 12 (12A, 12B, 12C, 12D) were removed and the time of removal are recorded in the detection sequence recording units in SRAM 22A (step S2).

The bottom panel 11 can be removed when all of the screws are removed, and the technician can perform any maintenance operations on the control circuit board 20 (step S3). When maintenance is completed, the screws 12 (12A, 12B, 12C, 12D) are attached through the bottom panel 11. This causes the push switches 21 (21A, 21B, 21C, 21D) of the control circuit board 20 to turn from off to on (step S4). Note that the screws may be replaced in any desired order when maintenance is completed, and the order in which the screws are replaced may also be recorded.

When the printer 1 power is turned on after maintenance is completed (step S5), power is also supplied to the control circuit board 20 of the anti-tamper device 3, and the anti-tamper control CPU 25 executes the process of the startup sequence executed when the power turns on. The anti-tamper control CPU 25 communicates with the real-time clock counter 22 and acquires the screw 12 removal sequence and the time data from the SRAM 22A (step S6). The anti-tamper control CPU 25 then compares the acquired removal sequence and time data with the authorized removal order for the time that the screws were removed (step S7), and determines if the screws were removed in the order that is authorized for the time when the screws were removed (step S8).

In this embodiment of the invention the pattern of the authorized removal order is changed at a regular time interval (such as every hour), and if the screw removal time is known, the screw removal order can be determined from the time. In addition, if the time when the technician will open the anti-tamper device is close to the time when the pattern of the authorized removal order is to change, the administration center may also inform the technician when the time is to change.

Note, further, that the pattern data for the authorized removal order at specific times (the specified sequence of the state changes in the plural sensors) may be stored in SRAM 22A or in a specified sequence recording unit that can store the data even when the printer 1 power is off, such as in nonvolatile memory (not shown in the figure) in the anti-tamper control CPU 25, or in ROM device 27, for example.

If the screws were removed in the authorized removal order for the time when the screws were removed (step S8 returns Yes), the printer 1 operates normally.

If the screws were not removed in the authorized removal order for the time when the screws were removed (step S8 returns No), the anti-tamper control CPU 25 sends an error report command to the printer control CPU 26. The printer control CPU 26 receives the error report command, and limits specific operations of the printer 1 (step S9). As a result, the printer 1 does not operate normally when the power is turned on. Alternatively, the printer 1 may perform a specific operation. For example, a buzzer may be sounded or an error may be displayed on a liquid crystal display (LCD) or light-emitting diode (LED) display device not shown to inform the user of the possibility of illicit opening. Yet further preferably, access to the electronic journal memory 28 that records confidential data may be prohibited, for example.

This embodiment of the invention compares the specified sequence recorded in the specified sequence recording unit with the order in which the state changes of the plural push switches 21 (21A, 21B, 21C, 21D) were recorded to the detection sequence recording units according to the order in which the screws 12 were removed from the bottom panel 11. If the orders differ, there may have been unauthorized access to, for example, the electronic component (electronic journal memory 28) recording confidential data. As a result, specific operations of the printer 1 are limited so that the printer 1 cannot operate normally when the power is turned on.

The operator can also be informed of the possibility of unauthorized access by sounding a buzzer or displaying an error message on an LCD or LED display unit not shown when the power turns on. Reading, erasing, and writing data can also be prevented by prohibiting access to the electronic journal memory 28, for example, that stores confidential data.

Yet further, because the authorized removal order changes and differs according to the time, the possibility of information leaks can be reduced by having an administration center manage the authorized removal order information, and the security level of anti-tamper protection can be improved.

Note that because the real-time clock counter 22 counts the year, month, date, hour, minute, and second, the authorized removal order may be changed at any desired time interval. As a result, the authorized removal order pattern may be changed at a predetermined time interval, and the patterns may be changed each day, for example.

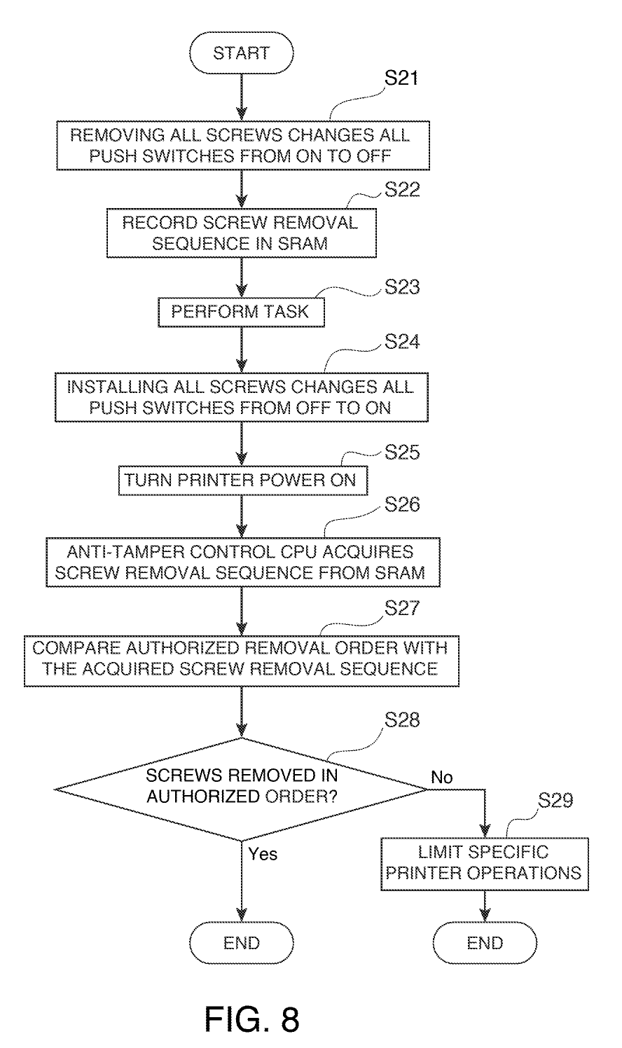

The electronic device control method of the anti-tamper device according to another embodiment of the invention is described next with reference to the flow chart in FIG. 8. FIG. 8 is a flow chart illustrating steps in another control method for an electronic appliance having an anti-tamper device according to an embodiment of the invention.

In this embodiment of the invention the authorized removal order of the screws 12 (12A, 12B, 12C, 12D) in the bottom panel 11 does not change according to the time.

When maintenance of the control circuit board 20 in the printer 1 is required, the technician turns the printer 1 power off and then removes all of the screws 12 (12A, 12B, 12C, 12D) in the bottom panel 11 in the authorized removal order. This authorized removal order is previously communicated from the administration center to the technician. The push switches 21 (21A, 21B, 21C, 21D) of the control circuit board 20 thus turn from on to off in the order in which they are removed (step S21).

When the state of a push switch 21 changes, the input signal level of the input nodes A to D of the real-time clock counter 22 changes from low to high, and the input node name and time are recorded in the order in which the state changes occur to a specific plurality of storage areas (addresses) that are the detection sequence recording units in the SRAM 22A. More specifically, the order in which the screws 12 (12A, 12B, 12C, 12D) were removed and the time of removal are recorded in the detection sequence recording units in SRAM 22A (step S22).

The bottom panel 11 can be removed when all of the screws are removed, and the technician can perform any maintenance operations on the control circuit board 20 (step S23). When maintenance is completed, the screws 12 (12A, 12B, 12C, 12D) are attached through the bottom panel 11. This causes the push switches 21 (21A, 21B, 21C, 21D) of the control circuit board 20 to turn from off to on (step S24). Note that the screws may be replaced in any desired order when maintenance is completed, and the order in which the screws are replaced may also be recorded.

When the printer 1 power is turned on after maintenance is completed (step S25), the anti-tamper control CPU 25 communicates with the real-time clock counter 22 and acquires the screw 12 removal sequence from the SRAM 22A (step S26). The anti-tamper control CPU 25 then compares the acquired removal sequence with the authorized removal order (step S27), and determines if the screws were removed in the authorized order (step S28).

Note, further, that the pattern data for the authorized removal order (the specified sequence of the state changes in the plural sensors) may be stored in SRAM 22A or in a specified sequence recording unit that can store the data even when the printer 1 power is off, such as in nonvolatile memory (not shown in the figure) in the anti-tamper control CPU 25, or in ROM device 27, for example.

If the screws were removed in the authorized removal order (step S28 returns Yes), the printer 1 operates normally.

If the screws were not removed in the authorized removal order (step S28 returns No), the anti-tamper control CPU 25 sends an error report command to the printer control CPU 26. The printer control CPU 26 receives the error report command, and limits specific operations of the printer 1 (step S29). As a result, the printer 1 does not operate normally when the power is turned on. Alternatively, the printer 1 may perform a specific operation. For example, a buzzer may be sounded or an error may be displayed on an LCD or LED display device not shown to inform the user of the possibility of illicit opening. Yet further preferably, access to the electronic journal memory 28 that records confidential data may be prohibited, for example.

This embodiment of the invention compares the specified sequence recorded in the specified sequence recording unit with the order in which the state changes of the plural push switches 21 (21A, 21B, 21C, 21D) were recorded to the detection sequence recording units according to the order in which the screws 12 were removed from the bottom panel 11. If the orders differ, there may have been unauthorized access to, for example, the electronic component (electronic journal memory 28) recording confidential data. As a result, specific operations of the printer 1 are limited so that the printer 1 cannot operate normally when the power is turned on.

The operator can also be informed of the possibility of unauthorized access by sounding a buzzer or displaying an error message on an LCD or LED display unit not shown when the power turns on. Reading, erasing, and writing data can also be prevented by prohibiting access to the electronic journal memory 28, for example, that stores confidential data.

It will be obvious to one with ordinary skill in the related art that the invention is not limited to the foregoing embodiments. For example, the number of screws 12 in the bottom panel 11 may be any plural number of screws and is not limited to four. Bolts or other fasteners may also be used instead of screws 12. Yet further, the push switches 21 may turn off when pressed, and a state change from high to low level may be detected as the change in the level of the signals input to the input nodes (A to D) of the anti-tamper control CPU 25.

Yet further, the invention is not limited to using push switches 21, and any type of sensor that can detect the installation and removal of the fasteners can be used instead.

In addition, when the firmware of the printer 1 is upgraded, the authorized removal order data may be changed to further enhance the security of anti-tamper protection.

The anti-tamper device of the invention is also not limited to use in printers, and can be used in other types of electronic devices.

When the invention is employed, the reliability and durability of the sensors can also be improved by using push switches. For example, a sensor configuration in which current is passed when the distal end of a screw 12 contacts a wiring pattern rendered on the control circuit board 20 is also conceivable. With such a sensor configuration, however, pressure from the distal ends of the screws 12 may create an unstable conduction state, and wear from the distal ends of the screws 12 on the electrode pattern may cause durability problems. Compared with such methods, using complete push switches is an effective means of assuring reliability and durability when the invention is employed.

The anti-tamper device and the method of controlling an anti-tamper device according to the invention are particularly effective when used in a fiscal printer having a function for storing and holding fiscal information related to receipt printing and sales information in electronic journal memory.

In addition to simply printing text similarly to a common printer, fiscal printers have a function for storing and retaining transaction information (fiscal information) such as sale and tax information related to product sales, and are used as cash register printers in POS systems. The fiscal information that must be stored is typically determined by the laws of a particular country, for example, and is stored and held in a storage device called electronic journal memory or fiscal memory. Furthermore, because the fiscal information is used for tax audits, for example, it is stored and retained in electronic journal memory such as a nonvolatile memory device sealed in a resin package so that it cannot be accessed and tampered with externally. Therefore, as shown in FIG. 4 and FIG. 6, by mounting the electronic journal memory on the control circuit board 20 and disposing the control circuit board 20 in the anti-tamper device, only authorized parties can legitimately remove the cover (bottom panel 11) of the anti-tamper device and retrieve the data stored in the electronic journal memory.

Furthermore, the cover (bottom panel 11) may also be removed for maintenance, such as when there is a bug in a program installed in ROM mounted on the control circuit board 20. Therefore, by storing and retaining the date and time when the cover (bottom panel 11) is removed, and confirming whether the cover (bottom panel 11) was removed with proper authority or whether the cover was removed for some illicit purpose such as tampering with or improperly reading the data stored in the electronic journal memory, tampering can be reliably detected and the security of the fiscal printer can be improved.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. An anti-tamper device comprising:
an electronic component that records specific data;
a case housing the electronic component thereinside;
a cover that covers the case;
a plurality of fasteners that fasten the cover to the case;
a plurality of sensors that are disposed in the case and change state when the fasteners are removed;
a control unit that detects the state changes of the sensors;
a specified sequence recording unit that records a specified sequence for state changes in the sensors; and
a detection sequence recording unit that records the order in which the state changes of the sensors were detected when the control unit detects a state change in the sensors,
wherein the control unit compares the specified sequence recorded in the specified sequence recording unit with the detected order of the state changes in the sensors recorded in the detection sequence recording unit, and when the compared sequences differ, limits one or more specific operations of an electronic appliance or causes the electronic appliance to execute one or more specific operations.

2. The anti-tamper device of claim 1, further comprising a timer, and wherein the control unit changes the specified sequence recorded in the specified sequence recording unit based on time kept by the timer.

3. The anti-tamper device of claim 1, wherein the control unit detects state changes in the sensors when the fasteners are installed.

4. The anti-tamper device of claim 1, wherein the control unit compares the specified sequence recorded in the specified sequence recording unit with the detected order of the state changes in the sensors recorded in the detection sequence recording unit when power supplied to the anti-tamper device is turned on.

5. The anti-tamper device of claim 4, further comprising a battery connected to the sensors and the detection sequence recording unit, and wherein the detection sequence recording unit is operable to record the order in which the fasteners are removed when the electronic appliance is switched off.

6. The anti-tamper device of claim 5, further comprising a timer connected to the battery.

7. The anti-tamper device of claim 1, wherein the sensors comprise push switches, each push switch opening or closing on contact with a distal end of one of the fasteners.

8. A control method for an electronic appliance having an anti-tamper device, the method comprising:
detecting a removal sequence of a plurality of fasteners from the electronic appliance;
comparing a specified removal sequence with the determined removal sequence; and
when the compared sequences differ, limiting one or more specific operations of the electronic appliance or causing the electronic appliance to execute one or more specific operations.

9. The control method of claim 8, wherein detecting a removal sequence comprises:
monitoring the installation states of the fasteners via a corresponding plurality of sensors; and
recording the order in which state changes of the sensors are detected in a detection sequence recording unit.

10. The control method of claim 9, further comprising storing the specified removal sequence in a specified sequence recording unit.

11. The control method of claim 10, further comprising changing the specified removal sequence based on time kept by the timer.

12. The control method of claim 8, further comprising providing electrical power from a battery so that the detecting a removal sequence of a plurality of fasteners occurs even when at least one of electrical power is not supplied to the electrical appliance or the electrical appliance is switched off.

13. The control method of claim 12, wherein the comparing a specified removal sequence with the determined removal sequence occurs upon switching the electrical appliance on.

14. A fiscal printer comprising:
an electronic journal memory that records fiscal information related to sales transactions;
a case housing the electronic journal memory thereinside;
a cover that covers the case;
a plurality of fasteners that fasten the cover to the case;
a plurality of sensors that are disposed in the case and change state when the fasteners are removed;
a control unit that detects the state changes of the sensors;
a specified sequence recording unit that records a specified sequence for state changes in the sensors; and
a detection sequence recording unit that records the order in which the state changes of the sensors were detected when the control unit detects a state change in the sensors;
the control unit comparing the specified sequence recorded in the specified sequence recording unit with the detected order of the state changes in the sensors recorded in the detection sequence recording unit, and prohibiting access to the electronic journal memory when the compared sequences differ.

15. The fiscal printer of claim 14, further comprising a timer, and wherein the control unit changes the specified sequence recorded in the specified sequence recording unit based on time kept by the timer.

16. The fiscal printer of claim 14, wherein the control unit detects state changes in the sensors when the fasteners are installed.

17. The fiscal printer of claim 14, wherein the control unit compares the specified sequence recorded in the specified sequence recording unit with the detected order of the state changes in the sensors recorded in the detection sequence recording unit when power supplied to the control unit is turned on.

18. The fiscal printer of claim 17, further comprising a battery connected to the sensors and the detection sequence recording unit, and wherein the detection sequence recording unit is operable to record the order in which the fasteners are removed when the fiscal printer is switched off.

19. The fiscal printer of claim 18, further comprising a timer connected to the battery.

20. The fiscal printer of claim 19, wherein the sensors comprise push switches, each push switch opening or closing on contact with a distal end of one of the fasteners.
